(19) United States
(12) Patent Application Publication
(10) Pub. No.: US 2008/0216411 A1
(43) Pub. Date: Sep. 11, 2008

(54) Weatherstrip and manufacturing method therefor

(75) Inventors: Kurato Okajima, Aichi-ken (JP); Masanori Aritake, Aichi-ken (JP); Satoshi Toki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD, Aichi-ken (JP)

(21) Appl. No.: 12/071,397

(22) Filed: Feb. 20, 2008

(30) Foreign Application Priority Data
Feb. 21, 2007 (JP) P2007-040952

(51) Int. Cl. E06B 7/16

(52) U.S. Cl. 49/475.1; 49/490.1; 49/506

(57) ABSTRACT

A weatherstrip is mounted along a peripheral part of a door opening of an automobile. The weatherstrip has a body including a cross-sectionally substantially-U-shaped trim portion, and a hollow seal portion. Additionally, a design lip is formed on the trim portion to extend therefrom. Then, a decorative layer formed of a woven fabric is provided on a design surface of the weatherstrip through a hotmelt adhesive layer. The woven fabric constituting the decorative layer is constituted by raw yarns. Also, a hotmelt adhesive layer is thermally fused thereto due to residual heat in a case where the body is cooled to a temperature, which is equal to or lower than a predetermined value, after vulcanization of a material of the body. Thus, the decorative layer is attached to a weatherstrip body.

### BACKGROUND OF THE INVENTION

1. Field of the Invention

The present invention relates to a weatherstrip for use along a peripheral part of a door opening of a vehicle, such as an automobile, and to a manufacturing method therefor.

2. Related Art

Hitherto, it has been considered to improve the quality of the appearance of the interior equipment of a vehicle, such as an automobile, by attaching a woven fabric to the interior equipment of a vehicle, such as an automobile. The interior equipment is, for example, a ceiling board of a vehicle interior.

Also, weatherstrips are provided along peripheral parts of door openings of vehicles. For example, a weatherstrip having the following components is known, that is, a cross-sectionally substantially-U-shaped trim portion which is fit into a flange formed along a peripheral part of a door opening, and a hollow seal portion provided to protrude from the trim portion. When a door is closed, the seal portion is press-contacted with a peripheral part portion of the door. Consequently, the space between the door and the body is sealed.

In recent years, it has been considered to attach a woven fabric to a design surface of the aforementioned weatherstrip other than the interior equipment, such as the ceiling board (see, e.g., JP-A-2006-232144).

Meanwhile, generally, the aforementioned weatherstrip is formed by extrusion-forming. In a case where the weatherstrip is made of a rubber material, such as EPDM (ethylene propylene diene copolymer) rubber, extrusion-forming is performed on an unvulcanized rubber material. Subsequently, the extrusion-formed material undergoes a vulcanization process. Thus, the vulcanization of the rubber material is achieved. Accordingly, in a case where it is considered to attach a woven fabric to a surface of the material in a sequence of steps of the extrusion-process, it is effective to attach the woven fabric to the surface of the material through an adhesive layer in a state, in which the surface of the material is heated, immediately after the vulcanization process.

However, in the case of performing the aforementioned thermal adhesion, there is concern that the woven fabric may contract. Thus, hitherto, crimped yarns having preliminarily undergone false twisting have been used as a material constituting a woven fabric.

On the other hand, the weatherstrip including a decorative layer formed of the woven fabric can have a quality appearance. However, such a weatherstrip is extremely costly. Accordingly, such a weatherstrip can be used in what is called a luxury automobile. However, it is extremely difficult to provide such a weatherstrip in a relatively inexpensive automobile constrained in cost.

### SUMMARY OF THE INVENTION

The invention is accomplished to solve aforementioned problems. An object of the invention is to provide a weather strip and a manufacturing method therefor, which can assure excellent quality appearance and achieve an extreme reduction in cost.

Hereinafter, means suitable for solving the aforementioned problems are described by itemizing. Incidentally, if necessary, characteristic operations and advantages are described in addition to the description of an associated one of such means.

Means 1: a weatherstrip (hereunder referred to as a first weatherstrip of the invention), which is featured in comprising a weatherstrip body, and a decorative layer formed of a woven fabric attached to a surface of the weatherstrip body through a hotmelt adhesive layer. The first weatherstrip of the invention is featured in that the woven fabric constituting the decorative layer is constituted by raw yarns.

Thus, the term “raw yarns” designate long chemical or synthetic fibers in their natural state as formed, which are not false-twisted and differ from what are called “silks”. A practical example of the “raw yarns” is multifilament yarns including filaments of polyester, such as polyethylene terephthalate.

According to the means 1, the presence of the decorative layer formed of the woven fabric gives what is called a fabric feeling and a feeling of luxury. Thus, the quality of appearance can be assured. Additionally, the woven cloth constituting the decorative layer is constituted by raw yarns. Accordingly, the cost of the woven fabric itself can be reduced to an extremely low level. Consequently, the cost of the entire weatherstrip can be reduced. Also, such a weatherstrip can be provided in a relatively inexpensive vehicle constrained in cost.

Means 2: a weatherstrip (hereunder referred to as a second weatherstrip of the invention) having a weatherstrip body including a cross-sectionally substantially-U-shaped trim portion which is held by a flange formed along a peripheral part of a door opening of a vehicle, and including also a hollow seal portion which is provided to protrude from the trim portion and which is press-contacted with a peripheral part of a door when the door is closed, and a decorative layer formed of a woven fabric attached to an outer surface of the trim portion through a hotmelt adhesive layer. The second weatherstrip of the invention is featured in that the woven fabric constituting the decorative layer is constituted by raw yarns.

According to Means 2, because of the presence of the decorative layer attached to the outer surface of the trim portion in the second weatherstrip of the invention having a cross-sectionally substantially-U-shaped trim portion and a hollow seal portion, advantages similar to those of the aforementioned Means 1 can be obtained.

Means 3: a weatherstrip (hereunder referred to as a third weatherstrip of the invention) having a weatherstrip body that includes a cross-sectionally substantially-U-shaped trim portion which is held by a flange formed along a peripheral part of a door opening of a vehicle, a hollow seal portion which is provided to protrude from the trim portion and is press-contacted with a peripheral part of a door when the door is closed, and a lip portion extended from the outer surface of the trim portion, and a decorative layer formed of a woven fabric attached to an outer surface of the lip portion through a hotmelt adhesive layer. The third weatherstrip of the invention is featured in that the woven fabric constituting the decorative layer is constituted by raw yarns.

According to Means 3, because of the presence of the decorative layer attached to the outer surface of the trim portion in the third weatherstrip of the invention having a cross-sectionally substantially-U-shaped trim portion, a hollow seal portion, and a lip portion extended from the outer surface of the trim portion, advantages similar to those of the aforementioned Means 1 can be obtained.

Means 4: an embodiment (hereunder referred to as a fourth weatherstrip of the invention) of one of the first to third weatherstrips of the invention is featured in that the weatherstrip body is made of a rubber material, that each of the raw yarns is made of polyester long-fibers, and that the hotmelt adhesive layer is made of a material capable of bonding the woven fabric thereto by residual heat immediately after vulcanization of the rubber material.

According to Means 4, the hotmelt adhesive layer melts due to residual heat immediately after vulcanization of the rubber material constituting the weatherstrip body. Then, the woven fabric made of polyester long fibers is bonded to the weatherstrip body. Thus, the decorative layer is formed. Accordingly, there is no particular necessity of providing a heating unit used for thermal adhesion. Consequently, the configuration of the apparatus can be simplified.

Means 5: a manufacturing method (a first manufacturing method of the invention) for one of the first to fourth weatherstrips, which is featured by comprising an extrusion forming step of preforming extrusion-forming on unvulcanized ethylene propylene diene copolymer (EPDM) rubber so as to form the weatherstrip body, a vulcanization step of vulcanizing the unvulcanized EPDM rubber having been extrusion-formed, and a decorative-layer forming step of press-contacting a predetermined outer surface of the woven fabric with the vulcanized EPDM rubber through the hotmelt adhesive layer and forming the decorative layer constituted by the woven fabric by thermally fusing the hotmelt adhesive layer thereto using residual heat of the vulcanization.

According to Means 5, in the extrusion forming step, the extrusion-forming is performed on unvulcanized EPDM rubber. In the vulcanization step, the unvulcanized EPDM rubber having been extrusion-formed is vulcanized. Then, in the decorative-layer forming step, the predetermined outer surface of the woven fabric is press-contacted with the vulcanized EPDM rubber through the hotmelt adhesive layer. Also, the decorative layer constituted by the woven fabric is formed by thermally fusing the hotmelt adhesive layer thereto using residual heat of the vulcanization. Thus, the decorative layer can be formed due to the residual heat generated in the vulcanization in a sequence of steps of the extrusion-forming process. Consequently, as described in the description of Means 4, there is no particular necessity of providing a heating unit used for thermal adhesion. Accordingly, the configuration of the apparatus can be simplified.

Means 6: an embodiment (hereunder referred to as a second manufacturing method of the invention) of the first manufacturing method of the invention, which is featured by further comprising, between the vulcanization step and the decorative-layer forming step, a cooling step of cooling a temperature of the predetermined outer surface of the vulcanized EPTM rubber to a temperature which is equal to or lower than a predetermined temperature.

Generally, the woven fabric used in each of Means 1 to 6 is liable to thermally contract, because the woven fabric is formed of raw yarns that are not false-twisted. Therefore, in a case where the temperature of the predetermined outer surface of the vulcanized EPDM rubber is too high, there is a fear that the woven fabric may be heat-shrunk, and that thus, the appearance may be adversely affected. However, according to Means 6, in the cooling step provided between the vulcanization step and the decorative layer forming step, the temperature of the predetermined outer surface of the vulcanized EPTM rubber is cooled to the temperature which is equal to or lower than the predetermined temperature. Consequently, occurrence of problems due to the too-high degree of the thermal contraction of the woven fabric can be suppressed.

Means 7: an embodiment (hereunder referred to as a third manufacturing method of the invention) of the second manufacturing method of the invention, which is featured in that in the cooling step, the temperature of the outer surface of the vulcanized EPDM rubber is cooled by simultaneously uniformized.

Generally, it is frequent to embed a metallic reinforcing member called an “insert” in the weatherstrip body. Particularly, in such a case, the temperature of the vicinity of the insert may be raised to an extremely high value through the vulcanization step. In this case, just after the vulcanization, the temperature may vary with parts of the weatherstrip. However, according to Means 7, the temperature of the predetermined outer surface of the vulcanized EPDM rubber is cooled while uniformized. Accordingly, the quality of the appearance of the apparatus can be prevented from being adversely affected due to locally significant thermal contraction of the woven fabric.

### BRIEF DESCRIPTION OF THE DRAWINGS

FIG. 1 is a perspective view illustrating an automobile.

FIG. 2 is a cross-sectional view illustrating a weatherstrip according to an embodiment of the invention.

FIG. 3 is a cross-sectional view illustrating an intermediate formed product of the weatherstrip.

FIG. 4 is a partly enlarged cross-sectional view illustrating a hotmelt adhesive layer and a decorative portion.

FIG. 5 is a schematic view illustrating a part of a manufacturing line for manufacturing the weatherstrip.

FIG. 6A is a schematic view illustrating a manner of installation of a temperature detecting means and the like of a cooling apparatus.

FIG. 6B is a schematic view illustrating a manner of installation of a nozzle and the like of the cooling apparatus.

### DETAILED DESCRIPTION OF THE PREFERRED EMBODIMENTS

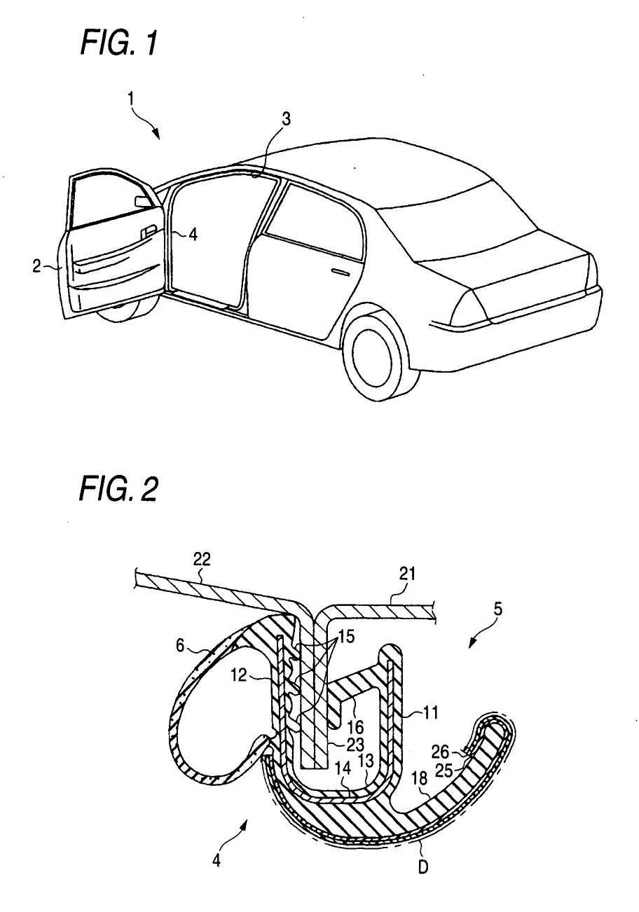

Hereinafter, an embodiment of the invention is described with reference to the accompanying drawings. As illustrated in FIG. 1, a door 2 is openably and closably provided in a side of an automobile 1 serving as a vehicle. A weatherstrip 4 is mounted along a peripheral part 3 of a body-side door opening 3, which corresponds to the door 2. The weatherstrip 4 according to the present embodiment is formed mainly by an extrusion-forming method and is annularly-shaped as a whole.

As illustrated in FIG. 2, the weatherstrip 4 has a trim portion 5 and a seal portion 6. The trim portion 5 has an interior-side side wall portion 11, exterior-side side wall portion 12, and a connection portion 13 for connecting both the side wall portions 11 and 12 to each other. The trim portion 5 is cross-sectionally substantially-U-shaped as a whole. The trim portion 5 is made of EPDM (ethylene propylene diene copolymer) solid rubber. A metal insert 14 is embedded in the trim portion 5.

A plurality of holding lip portions 15 extending toward the inner side (i.e., the exterior side) of the trim portion 5 are formed integrally with the inner surface (i.e., the interior-side surface) of the exterior-side side wall portion 12. A holding lip portion 16 extending toward the inner side (i.e., the exterior-side) of the trim portion 5 is formed integrally with the inner surface (i.e., the exterior-side surface) of the interior-side side wall portion 11. A design lip 18 covering an end portion of interior equipment, such as a garnish (not shown), is formed on the connection portion 13. Incidentally, the insert does not have to be embedded in the trim portion 5. Also, the trim portion 5 may be configured so that the holding lip is omitted, and that the trim portion 5 is attached to a flange 23 by double-sided adhesive tape.

The flange 23 is formed in the peripheral part of the door opening 3 by connecting an inner panel 21 and an outer panel of the body to each other. The weatherstrip 4 is held by the peripheral part of the door opening 3.

On the other hand, the seal portion 6 is provided integrally with the exterior-side side wall portion 12 to protrude from the exterior side of the side wall portion 12. The seal portion 6 is made of EPDM sponge rubber and is configured to be hollow. When the door 2 is closed, the seal portion 6 is press-contacted with the peripheral part of the door 2, so that the space between the door 2 and the automobile 1 is sealed by the seal portion 6.

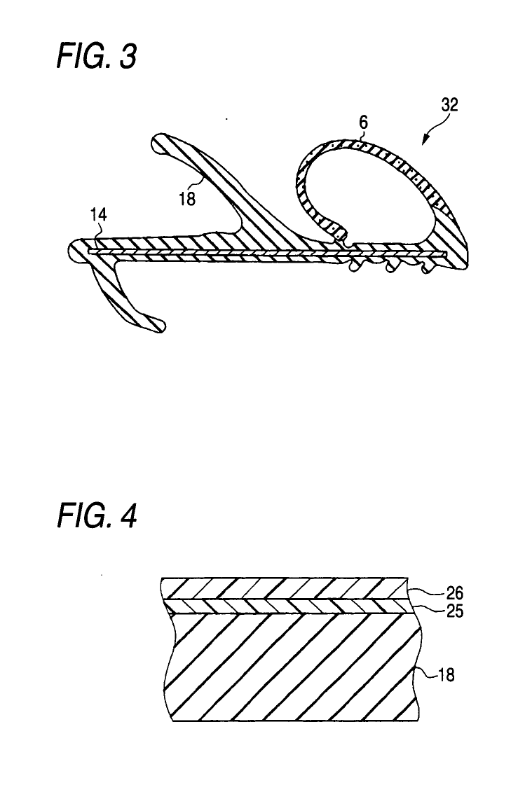

In a mounted state of the weatherstrip 4, an outer surface of a range extending from a substantially leading end portion to a base end portion of the design lip 18, through the connection portion 13 of the trim portion 5, to a connecting portion of the exterior-side side wall portion 12, which is connected to the seal portion 6, is a design surface D (corresponding to the “predetermined outer surface”) shown on the appearance of the weatherstrip 4. As illustrated in a partly enlarged cross-sectional view shown in FIG. 4, a decorative layer 26 formed of a woven fabric is formed on the design surface D through a hotmelt adhesive layer 25 shaped like a sheet (including film). As illustrated in FIGS. 2 and 3, the woven fabric is attached onto the design surface D up to the leading end of the design lip 18, and includes a folded-back portion.

The hotmelt adhesive layer 25 according to the present embodiment has a two-layer structure including a polyethylene (PE) layer, which is an olefin-based thermoplastic resin layer, and a polyethylene terephthalate (PET) layer that is a polyester-based thermoplastic resin layer. The hotmelt adhesive layer 25 is colored in a predetermined color. Apparently, the kind of the color, in which the hotmelt adhesive layer is colored, is not limited to a specific color. Any color (e.g., white, red, blue, or green) matched to the interior equipment, such as a garnish, can be employed as the color in which the hotmelt adhesive layer is colored. Incidentally, in a case where the color of the indoor interior equipment is based on black, sometimes, the color of the hotmelt adhesive layer is adjusted by adding black pigment to pigments for coloring the hotmelt adhesive layer so as to match the color and luster of the hotmelt adhesive layer to those of the interior equipment. The coloring of the hotmelt adhesive layer can be omitted.

Additionally, the decorative layer 26 according to the present embodiment is formed of a woven fabric made of long fibers of polyester, for example, polyethylene terephthalate (PET). Incidentally, the woven fabric according to the present embodiment uses what are called raw yarns that are long chemical or synthetic fibers in their natural state as formed, which are not false-twisted and crimped. Incidentally, according to the present embodiment, a coloring agent is mixed into a synthetic resin chip before fiber-spinning. Thus, the woven fabric is colored in a predetermined color (i.e., a color which is the same as that of the hotmelt adhesive layer 25).

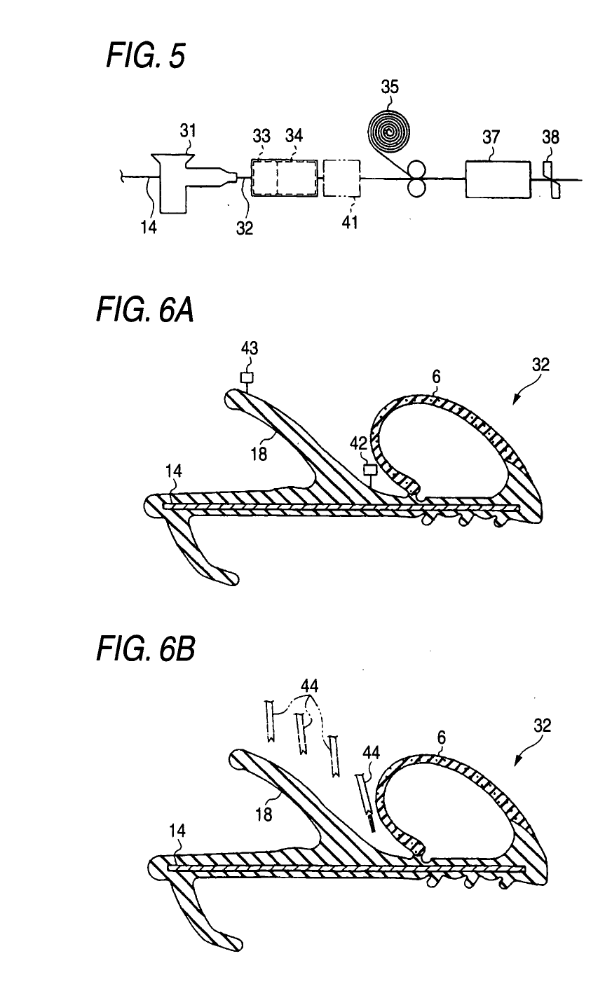

Next, a manufacturing method for the weatherstrip 4 is described below. FIG. 5 is a schematic view illustrating a part of a manufacturing line for manufacturing the weatherstrip 4. In FIG. 4, the weatherstrip 4 is manufactured while going from the left side to the right side, as viewed in FIG. 5.

First, in the extrusion-forming step, the insert 14 is continuously provided, together with the unvulcanized EPDM rubber to a rubber extruder 31. Then, an intermediate formed-product 32 (see FIG. 3), which is formed into a body portion of the weatherstrip 4, is extrusion-formed in a state, in which the insert 14 is coated with the EPDM unvulcanized, by being extruded from a die of the rubber extruder 31. In this stage, a part, in which an insert corresponding to the trim portion 5 is embedded, is extruded like a substantially flat plate in a state in which this part is opened, as illustrated in FIG. 3.

Subsequently, in a vulcanization step, the extruded intermediate formed-product 32 is guided to a high-frequency vulcanization tank (UHF) 33. In this tank, primary vulcanization is performed thereon. Then, the intermediate formed-product 32 is guided to a hot-air vulcanization tank (HAV) 34. In this tank, secondary vulcanization is performed thereon. Thus, the vulcanization is completed. Incidentally, just posterior to the hot-air vulcanization tank (HAV) 34, the temperature of a surface of the vulcanized EPDM rubber ranges, for example, from 170° C. to 180° C. In some places, the temperature of the surface of the vulcanized EPDM rubber may exceed 200° C. Thus, according to the present embodiment, a cooling apparatus 41 is provided at the just downstream side of the hot-air vulcanization tank (HAV) 34. The cooling apparatus 41 is provided with noncontact temperature measuring means 42 and 43 shown in FIG. 6A, an air blower (not shown), and nozzles shown in FIG. 6B, which are connected to the air blower. In the present embodiment, one 42 of the temperature measuring means is closest to the insert 14 and can measure the temperature of the root of the design lip 18, which can have a high temperature. The other temperature measuring means 43 is distant from the insert 14 and can measure the temperature of the leading end portion of the design lip 18, which is less apt to have a high temperature. An amount of air blown by the air blower, the number of the installed nozzles 44, and the installation locations of the nozzles 44 are preliminarily set so that the surface temperature measured by each of the temperature measuring means 42 and 43 has a nearly constant value which is lower than a predetermined value (e.g., as designated by a solid line shown in FIG. 6B, the nozzle 44 is installed so that only the root of the design lip 18 is positively cooled).

Consequently, the temperature of the design surface D of the vulcanized EPDM rubber is uniformized and is cooled to a value that is equal to or less than a predetermined temperature.

Subsequently, in a decorative layer forming step, the decorative layer 26 is formed on the intermediate formed-product. More specifically, a laminated woven fabric 35 obtained by backing the aforementioned woven fabric with the hotmelt adhesive layer 25 is played out and is press-contacted with a part of the intermediate formed-product 32, which corresponds to the design surface D and has a relatively high temperature immediately after the vulcanization. Consequently, (the PE layer of) the hotmelt adhesive layer 25 is molten. Thus, the laminated woven fabric 35 is heat-fused to the intermediate formed-product 32. At this heat-fusion, the temperature of the design surface D is equal to or lower than a predetermined temperature (e.g., 130° C. to 150° C.). Also, the temperature thereof is uniformized. Thus, heat contraction is hardly caused. Consequently, the uniform attachment of the woven fabric can be achieved.

Then, the intermediate formed-product 32 having undergone the decorative layer forming step is bent by a bending machine 37. Thus, a cross-sectionally substantially-U-shaped trim portion 5 can be formed. Subsequently, the trim portion 5 is cut by a cutter 38 to a predetermined size. Consequently, the weatherstrip 4 can be obtained.

As described above in detail, according to the present embodiment, the decorative layer 26 formed on the design surface D of the weatherstrip 4, which includes the outer surface of the design lip 18, is formed of the woven fabric. Thus, the appearance of the weatherstrip 4 can be a fabric style. Consequently, the weatherstrip 4 can have a beautiful appearance and an excellent texture.

Also, the woven fabric constituting the decorative layer 26 is formed of raw yarns. Thus, the cost of the woven fabric itself can be suppressed to an extremely low value. Consequently, the cost of the entire weatherstrip 4 can be reduced. The weatherstrip according to the invention can be provided in a relatively inexpensive automobile constrained in cost.

Additionally, the decorative layer can be formed due to the residual heat generated in the vulcanization in a sequence of steps of an extrusion-forming process. Consequently, as described in the description of Means 4, there is no particular necessity of providing a heating unit used for thermal adhesion. Accordingly, the configuration of the apparatus can be simplified.

Also, the woven fabric used in the present embodiment is liable to thermally contract, because the woven fabric is formed of raw yarns that are not false-twisted. Therefore, in a case where the temperature of the predetermined outer surface of the vulcanized EPDM rubber is too high, there is a fear that the woven fabric may be heat-shrunk, and that thus, the appearance may be adversely affected. However, in the cooling step provided between the vulcanization step and the decorative layer forming step, the temperature of the predetermined outer surface of the vulcanized EPDM rubber is cooled to the temperature which is equal to or lower than the predetermined temperature. Consequently, occurrence of problems due to the too-high degree of the thermal contraction of the woven fabric can be suppressed.

Additionally, a metal insert 14 is embedded in the weatherstrip body. Particularly, in such a case, the temperature of the vicinity of the insert tends to be raised to an extremely high value immediately after the vulcanization. In contrast with this, according to the invention, the temperature of the predetermined outer surface of the vulcanized EPDM rubber is cooled while uniformized. Accordingly, the quality of the appearance of the apparatus can be prevented from being adversely affected due to locally significant thermal contraction of the woven fabric.

Furthermore, according to the present embodiment, the hotmelt adhesive layer 25 and the decorative layer 26 are colored. Thus, the color of the EPDM rubber material, which is black, can be hidden. Consequently, in respect of hue, the weatherstrip 4 can have a beautiful appearance and an excellent texture. Additionally, the hotmelt adhesive layer 25 and the decorative layer 26 can be formed to have the same color. Consequently, the ability to hide the color of the material can be further enhanced.

Incidentally, the invention is not limited to the aforementioned embodiment described in the foregoing description thereof. The invention can be implemented, for example, in the following manners (a) to (f). Apparently, the invention can be applied to other cases of application and modification other than examples, which are exemplified below.

(a) Although the invention is embodied as the weatherstrip 4 provided along the peripheral part of the body-side door opening corresponding to the (side front) door 2 according to the aforementioned embodiment, the invention can be applied to weatherstrips provided along the peripheral parts of doors opposed to other doors, such as a rear door, a back door, a luggage door (i.e., a trunk lid), and a roof door (i.e., a sliding roof panel).

(b) The weatherstrips, in each of which the outer surface of the trim portion 5 is formed as a design surface, can be configured so that the design lip 18 is omitted, and that the hotmelt adhesive layer 25 and the decorative layer 26 are formed on the outer surface of the trim portion 5.

(c) Although EPDM rubber has been exemplified as the material of the weatherstrip 4 in the description of the aforementioned embodiment, other rubber materials, such as IR (isoprene rubber) and CR (chloroprene rubber), can be used as the material of the weatherstrip 4.

(d) Although PE and PET, which are the materials of the two-layer structure including the PE layer and the PET layer, have been exemplified as the materials of the hotmelt adhesive layer 25 in the description of the aforementioned embodiment, other resin materials can be used as those of the hotmelt adhesive layer 25.

(e) Although the weatherstrip 4 is mounted along the entire peripheral part of the door opening 3 in the aforementioned embodiment, the weatherstrip 4 can be not necessarily mounted along the entire peripheral part thereof. For example, the weatherstrip 4 can be mounted along a part of the peripheral part of the door opening 3. Alternatively, the weatherstrip 4 can be partly provided with a molded portion.

(f) Synthetic fibers (e.g., PE fibers, PP (polypropylene) fibers, and polyamide fibers) other than the PET fibers can be used as the raw yarns constituting the woven fabric.

What is claimed is:

1. A weatherstrip comprising:
a weatherstrip body; and
a decorative layer formed of a woven fabric attached to a surface of said weatherstrip body through a hotmelt adhesive layer,
wherein said woven fabric constituting said decorative layer is constituted by raw yarns.

2. A weatherstrip having:
a weatherstrip body including a cross-sectionally substantially-U-shaped trim portion which is held by a flange formed along a peripheral part of a door opening of a vehicle, and including also a hollow seal portion which is provided to protrude from said trim portion and which is press-contacted with a peripheral part of a door when said door is closed; and
a decorative layer formed of a woven fabric attached to an outer surface of said trim portion through a hotmelt adhesive layer, said weatherstrip,
wherein said woven fabric constituting said decorative layer is constituted by raw yarns.

3. A weatherstrip comprising:
a weatherstrip body including:
a cross-sectionally substantially-U-shaped trim portion which is held by a flange formed along a peripheral part of a door opening of a vehicle;
a hollow seal portion which is provided to protrude from said trim portion and is press-contacted with a peripheral part of a door when said door is closed; and
a lip portion extended from said outer surface of said trim portion; and
a decorative layer formed of a woven fabric attached to an outer surface of said lip portion through a hotmelt adhesive layer, said weatherstrip,
wherein said woven fabric constituting said decorative layer is constituted by raw yarns.

4. The weatherstrip according to claim 1, wherein said weatherstrip body is made of a rubber material;
each of said raw yarns is made of polyester long-fibers; and
said hotmelt adhesive layer is made of a material capable of bonding said woven fabric thereto by residual heat immediately after vulcanization of said rubber material.

5. A manufacturing method for said weatherstrip according to claim 1, comprising:
an extrusion forming step of preforming extrusion-forming on unvulcanized EPDM rubber so as to form said weatherstrip body;
a vulcanization step of vulcanizing said unvulcanized EPDM rubber having been extrusion-formed; and
a decorative-layer forming step of press-contacting a predetermined outer surface of said woven fabric with the vulcanized EPDM rubber through said hotmelt adhesive layer and forming said decorative layer constituted by said woven fabric by thermally fusing said hotmelt adhesive layer thereto using residual heat of the vulcanization.

6. The manufacturing method for said weatherstrip according to claim 5, further comprising, between said vulcanization step and said decorative-layer forming step, a cooling step of cooling a temperature of said predetermined outer surface of said vulcanized EPTM rubber to a temperature which is equal to or lower than a predetermined temperature.

7. The manufacturing method for said weatherstrip according to claim 6, wherein:
in said cooling step, the temperature of said outer surface of said vulcanized EPDM rubber is cooled by simultaneously uniformized.
